(19) United States
(12) Patent Application Publication
(10) Pub. No.: US 2003/0173849 A1
(43) Pub. Date: Sep. 18, 2003

(54) Field force manipulation powered motor

(76) Inventor: Herman H. Marshall JR., Louisville, CO (US)

Correspondence Address: HERMAN H. MARSHALL JR., 683 SUNNYSIDE STREET, LOUISVILLE, CO, 80027, US

(21) Appl. No.: 10/097,590

(22) Filed: Mar. 15, 2002

(51) Int. Cl. H02K 21/12

(52) U.S. Cl. 310/156.01

(57) ABSTRACT

The field force manipulation powered motor consists of gears, bearings, and magnets so arranged as to create and maintain a constant field force alignment conflict that results in the development of rotational energy.

Large stationary magnets establish a reference force field. Small magnets are rotationally constrained with their fields approximately 90-degrees out of alignment with the large magnets. The 90-degree misalignment between the fields of the large and small magnets creates a torque on the small magnets.

The small magnets are attached to small gears that are rotationally constrained by bearing housings, and meshing with large stationary gears. The rotational constraint manipulates the torque on the small magnets into movement that fails to attain the desired field alignment. The torque on the small magnets cause the small gears to walk around the large stationary gears and in doing so cause the bearing housings to rotate. The rotation of the bearing housings is the rotational energy output of the motor.

### CROSS-REFERENCE TO RELATED APPLICATIONS

Not applicable.

### BACKGROUND—FIELD OF INVENTION

This invention relates to various machines that produce rotational energy.

### BACKGROUND—FEDERALLY SPONSORED RESEARCH OR DEVELOPMENT

Not applicable.

### BACKGROUND—DESCRIPTION OF PRIOR ART

To the best of my knowledge there is no prior art for this device although all forms of motors could be assumed somewhat related. All current sources of rotational energy obtain their means of motivation from the combustion of fuel or an existing form of energy.

### SUMMARY

The field force manipulation powered motor produces rotational energy by manipulating magnetic field forces. It comprises large magnets so arranged that they create a circular path through which small magnets pass. The small magnets are manipulated by gears and bearing housings to remain in a predominately perpendicular field relationship with the large magnets. The predominately perpendicular field relationship causes the small magnets to have a torque placed on them. The torque on the small magnets is transferred to the small gears causing them to walk around large stationary gears. The small gears cause the bearing housings to rotate as the small gears walk around the large stationary gears. The relative size relationship between the small gears and the large gears cause the small magnets to be manipulated into the predominately perpendicular field relationship with the large magnets. The output of the motor is taken from one of the bearing housings.

### OBJECTS AND ADVANTAGES

Accordingly, several objects and advantages of my invention are . . .

It consumes no fuel or existing energy;

It therefore produces no pollutants;

It is as safe to operate as an electric motor;

It can be used on Earth or in space;

It can be miniaturized to replace batteries down to a “C” cell, and perhaps below;

It can be used as a source of energy in homes, buildings, and factories;

It eliminates the need for power lines, including natural gas;

It can be used with all means of land and sea transportation;

It should be no more expensive than an electric motor of equal capability;

Other objects and advantages include increased national security by eliminating energy expense fluctuations and funds entering the mid-east area where terrorism appears to originate.

### LIST OF FIGURES

FIG. 1 shows field of “V” shaped magnet.

FIG. 2 shows relative positions of small and large magnets.

FIG. 3 shows field confinement between two magnets.

FIG. 4 shows relative positions of small and large magnets.

FIG. 5 shows a side view cutaway of parts forming motor 1.

FIG. 6 shows top view cutaway of parts forming motor 1.

FIG. 7 shows exploded view of motor 1.

FIG. 8 shows motor 1 parts assembled, minus the case.

FIG. 9 shows motor 1 in its case.

FIG. 10 shows a side view cutaway of parts forming motor 2.

FIG. 11 shows top view cutaway of parts forming motor 2.

FIG. 12 shows exploded view of motor 2.

FIG. 13 shows motor 2 parts assembled, minus the outer magnet housing and the case.

FIG. 14 shows motor 2 in its case.

FIG. 15 shows a side view cutaway of motor 3.

FIG. 16 shows top view cutaway of motor 3.

FIG. 17 shows motor 3 parts assembled, minus the outer magnet housing and the case.

FIG. 18 shows motor 3 with the outer magnet housing in place, minus the case.

FIG. 19 shows motor 3 in its case.

### LIST OF REFERENCE NUMBERS

20 large magnets

21 small magnets

22 small gears

23 shaft protruding from small gear

24 lower stationary gear

25 upper stationary gear

26 upper bearing housing

27 small gear bearings

28 lower bearing housing

29 lower bearing

30 upper inner bearing

31 protrusion from upper stationary gear

32 upper outer bearing

33 output shaft protruding from upper bearing housing

34 cylindrical portion of case

35 lower case end

36 upper case end

37 assembly pin hole in upper stationary gear

38 assembly pin hole in upper bearing housing

39 assembly pin

50 large inner magnets

51 large outer magnets

52 small magnets

53 lower stationary gear

54 small gear

55 lower bearing housing

56 upper stationary gear

57 upper bearing housing

58 outer magnet housing

58′ outer magnet housing (rotatable)

59 outer bearings

60 output shaft protruding from upper bearing housing

61 small gear bearings

62 protrusion from upper stationary gear

63 shaft protruding from small gear

64 cylinder

65 assembly pin hole in upper bearing housing

66 assembly pin hole in upper stationary gear

67 assembly pin

68 assembly pin hole in upper case end

70 upper outer bearing

71 upper inner bearing

72 lower bearing

80 cylindrical portion of case

80′ cylindrical portion of case enlarged & ported

81 upper case end

81′ upper case end enlarged

82 lower case end

82′ lower case end enlarged

90 toothed or threaded area on outer magnet housing

91 adjustment shaft

92 toothed or threaded area on adjustment shaft

93 adjustment housing

94 adjustment case

### DESCRIPTION—PRELIMINARY

All gears are shown as wheels at the appropriate pitch diameter to allow interaction and the transfer of motion.

All magnets are assumed to be of equal field intensity at locations of maximum interaction.

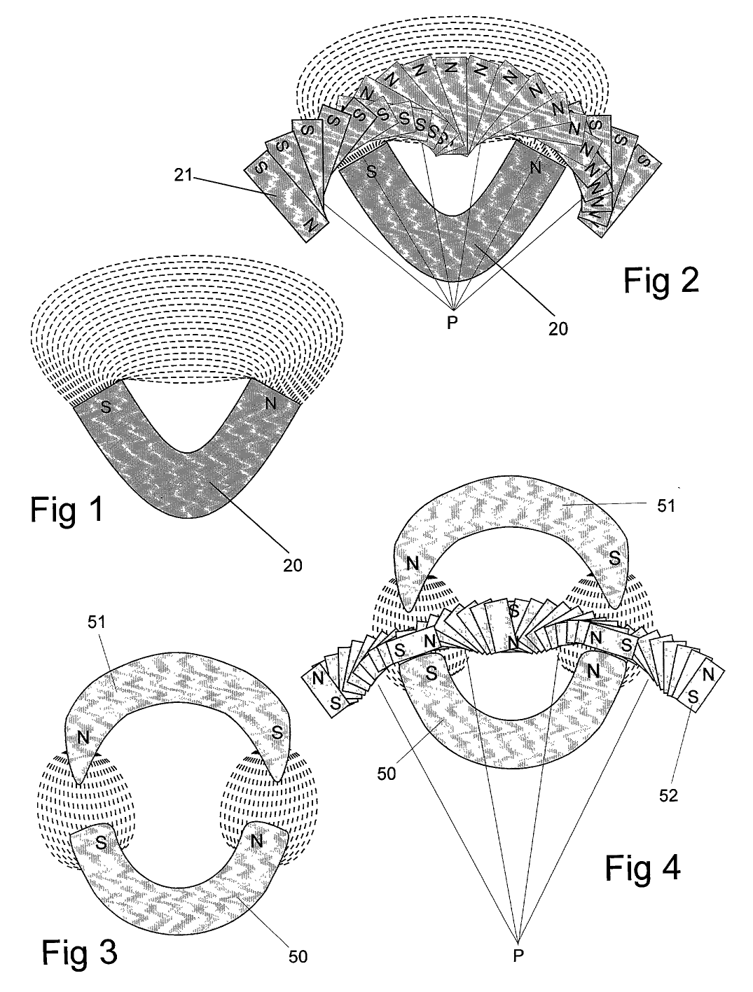

FIG. 1 shows an approximation of the field of large “V” shaped magnet (20).

FIG. 2 shows the relationship between large magnet (20) and small magnets (21).

FIG. 3 shows field confinement between two large magnets (50) and (51).

FIG. 4 shows the relationship between a large magnets (50) and (51) and small magnets (52).

### DESCRIPTION—EMBODIMENT 1

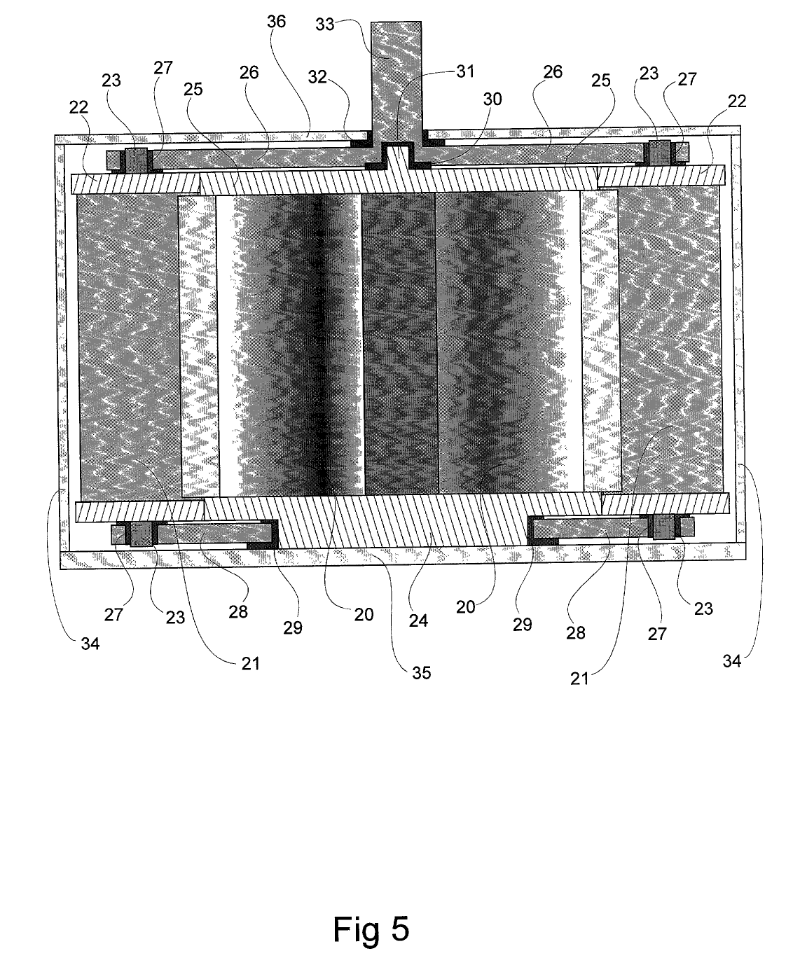

FIG. 5 shows a side view cutaway of embodiment 1 of the invention. Large inner magnets (20) are sandwiched between lower stationary gear (24) and upper stationary gear (25) and attached to both. A large extended surface on the bottom of lower stationary gear (24) is attached to the lower case end (35) and is the seat for bearing (29). Lower case end (35) is made of thick material.

Upper stationary gear (25) has protrusion (31) which is the seat for upper inner bearing (30). Upper inner bearing (30) is the inner bearing for upper bearing housing (26). Upper outer bearing (32) is the outer bearing for upper bearing housing (26) and is seated in upper case end (36). The cylindrical portion of case (34) is attached between the two case ends (35) and (36). Output shaft (33) protruding from upper bearing housing (26) is the output of the motor.

Small gears (22) are attached to each end of small magnets (21). Shafts (23) that protrude from one side of each small gear fit in the bearings (27) located in upper bearing housing (26) and lower bearing housing (28).

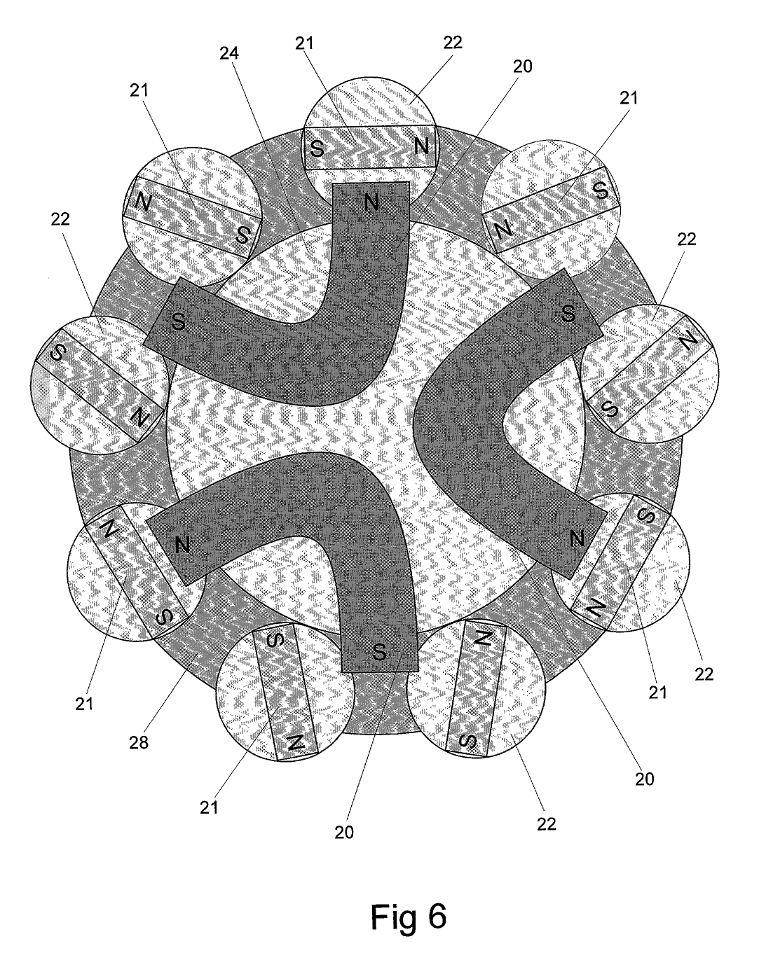

FIG. 6 shows a top view cutaway of the motor. The shapes and locations of parts are made more visible to permit understanding their interaction. Small gears (22) are held in position by lower bearing housing (28) and upper bearing housing (26). Teeth on small gears (22) mesh with teeth on lower stationary gear (24) and upper stationary gear (25). Small magnets (21) are shown in proper orientation.

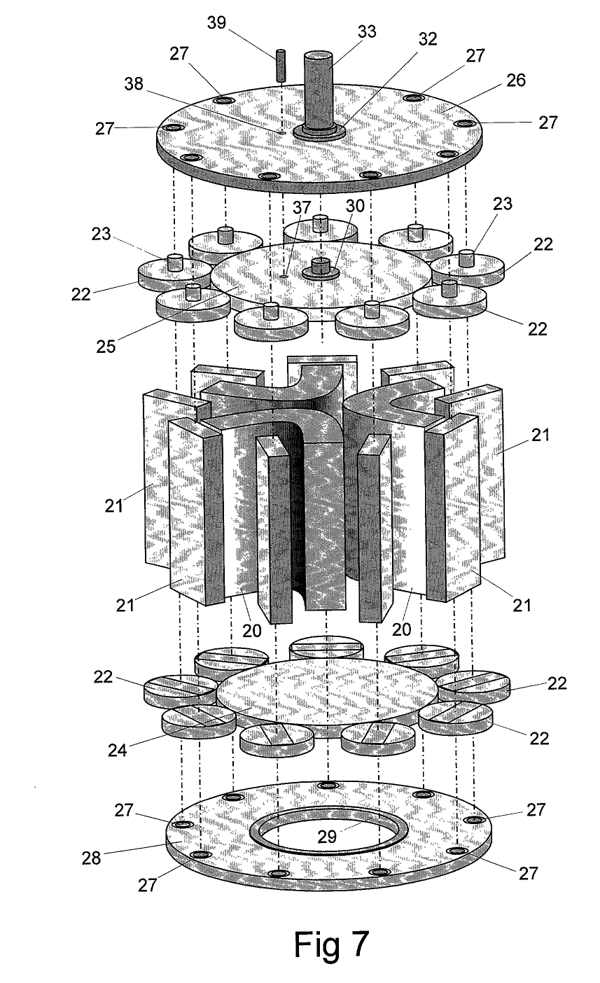

FIG. 7 shows an exploded view of the motor minus the case. Most parts have been explained, but are in three dimensions here. The footprints of the small magnets (21) are shown on the lower set of small gears (22) for orientation purposes. The lower bearing housing (28) has a large bearing surface (42) to allow lower stationary gear (24) to have a large attachment area to contact lower case end (35).

Hole (37) in the upper stationary gear (25) and hole (38) in the upper bearing housing (26) are there to accept assembly pin (39).

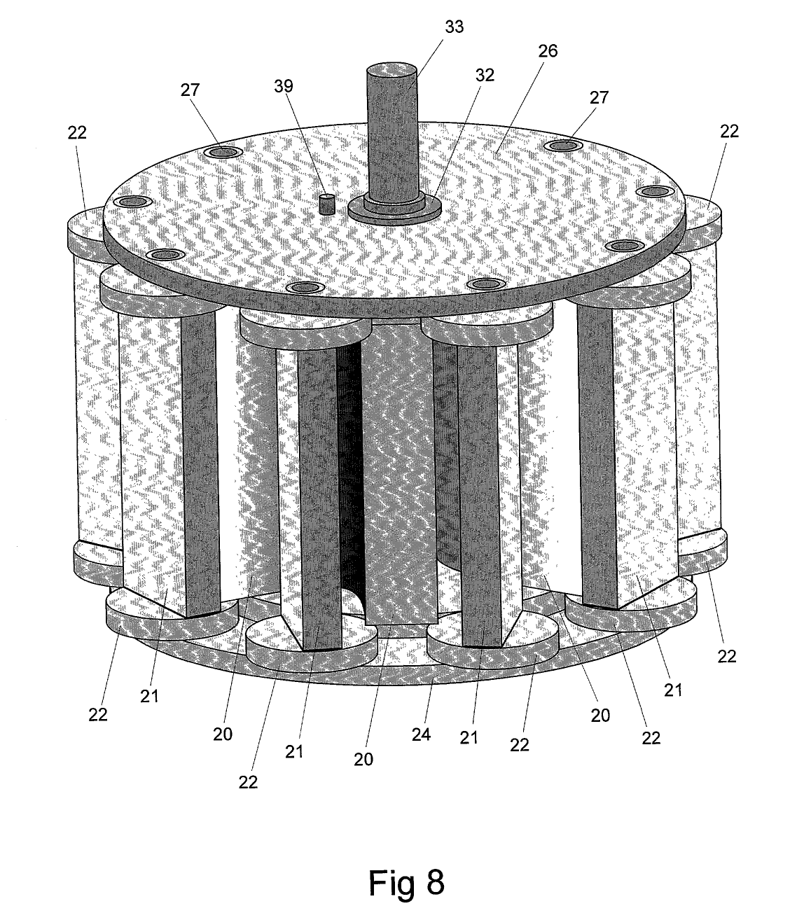

FIG. 8 shows the motor assembled without the case. Assembly pin (39) is shown inserted.

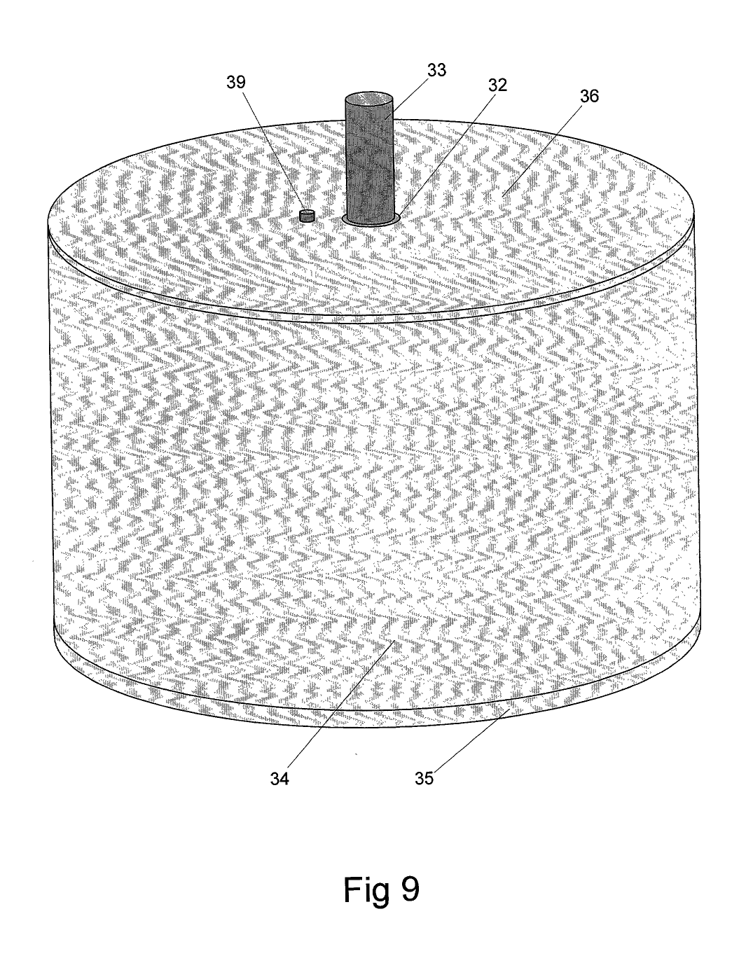

FIG. 9 shows the motor with the case installed. Assembly pin (39) remains inserted.

### OPERATION—EMBODIMENT 1

Attractive and repulsive forces are used indirectly to cause rotational movement in the motor. Small magnets (21) rotate as they orbit point “P” and pass through the fields of large magnets (20) as indicated on FIG. 2. The poles of small magnets (21) are attracted and repelled as they pass through the fields of large magnets (20). The attraction and repulsion of the poles on small magnets (21) cause small magnets (21) to twist in an attempt to attain field alignment with the fields of large magnets (20).

The twisting action of small magnets (21) is transferred to small gears (22) attached to each end of each small magnet (21) where the twisting action functions as torque. The torque on small gears (22) causes them to rotate and walk around stationary gears (24) and (25). As small gears (22) rotate and walk around stationary gears (24) and (25), they move with them bearing housings (26) and (28) where their bearings are located. The rotation of the upper bearing housing (25) rotates output shaft (33) which protrudes from the upper bearing housing.

Assembly pin (39) prevents the motor from operating prematurely and is not to be removed until the motor is installed and a load or governor is attached to the output shaft. Once assembly pin (39) is removed, the motor will continue to operate until failure occurs or sufficient load is applied.

### DESCRIPTION—EMBODIMENT 2

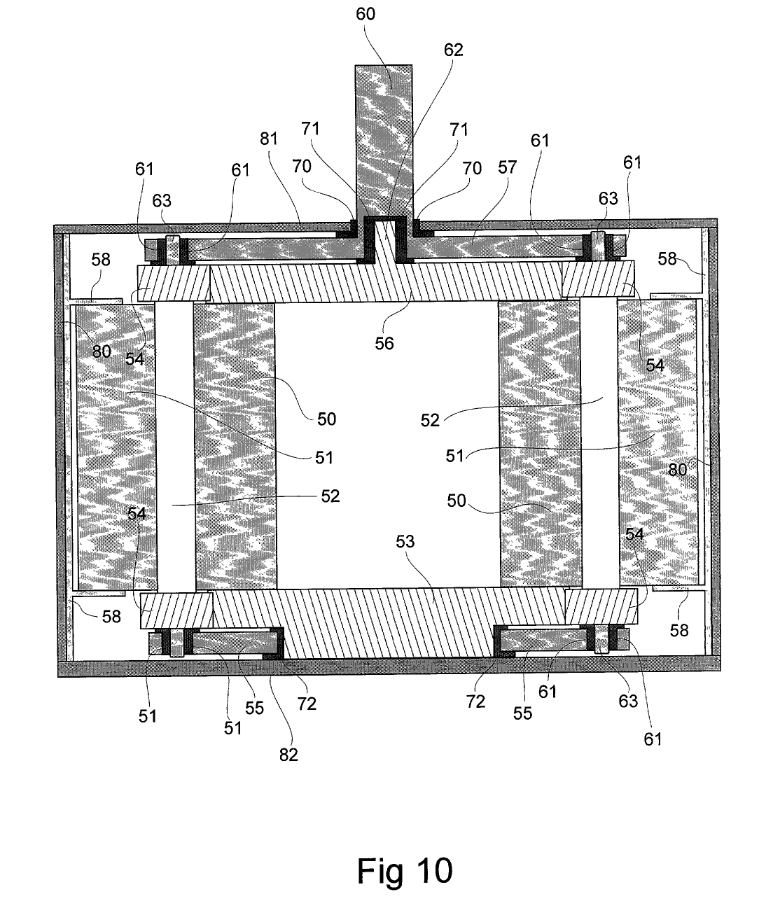

FIG. 10 shows a side view cutaway of embodiment 2 of the invention. Large inner magnets (50) are sandwiched between lower stationary gear (53) and upper stationary gear (56) and attached to both. An extended surface on the bottom of lower stationary gear (53) is attached to lower case end (82) and is the seat for bearing (72). Lower case end (82) is made of thick material.

Upper stationary gear (56) has protrusion (62) which is the seat for upper inner bearing (71). Upper inner bearing (71) is the inner bearing for upper bearing housing (57). Upper outer bearing (70) is the outer bearing for upper bearing housing (57) and is seated in upper case end (81). The cylindrical portion of case (80) is attached between the two case ends (81) and (82). Output shaft (60) protruding from upper bearing housing (57) is the output of the motor.

Small gears (54) are attached to each end of small magnets (52). Shafts (63) that protrude from one side of each small gear fit in bearings (61) located in lower bearing housing (55) and upper bearing housing (57). The large outer magnets (51) are held in place by outer magnet housing (58). The outer magnet housing (58) is seated between upper case end (81) and lower case end (82) and is attached to lower case end (82).

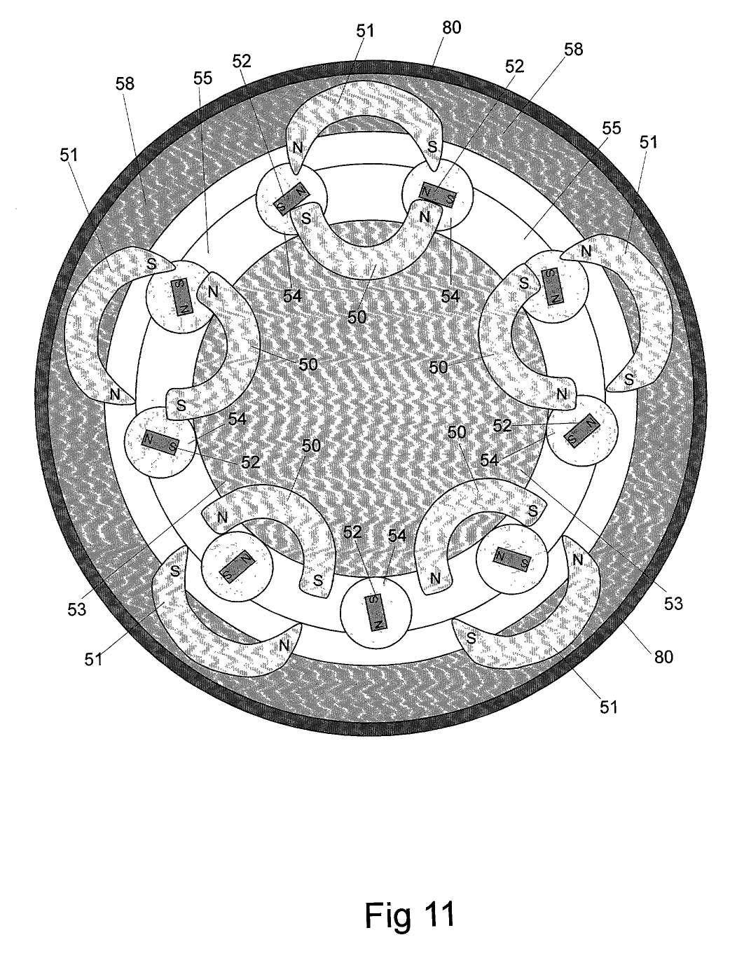

FIG. 11 shows a top view cutaway of the motor. The shapes and locations of parts are made visible to permit understanding their interaction. Small gears (54) are held in position by lower bearing housing (55) and upper bearing housing (57). Teeth on small gears (54) mesh with teeth on lower stationary gear (53) and upper stationary gear (56). Small magnets (52) are shown in proper orientation.

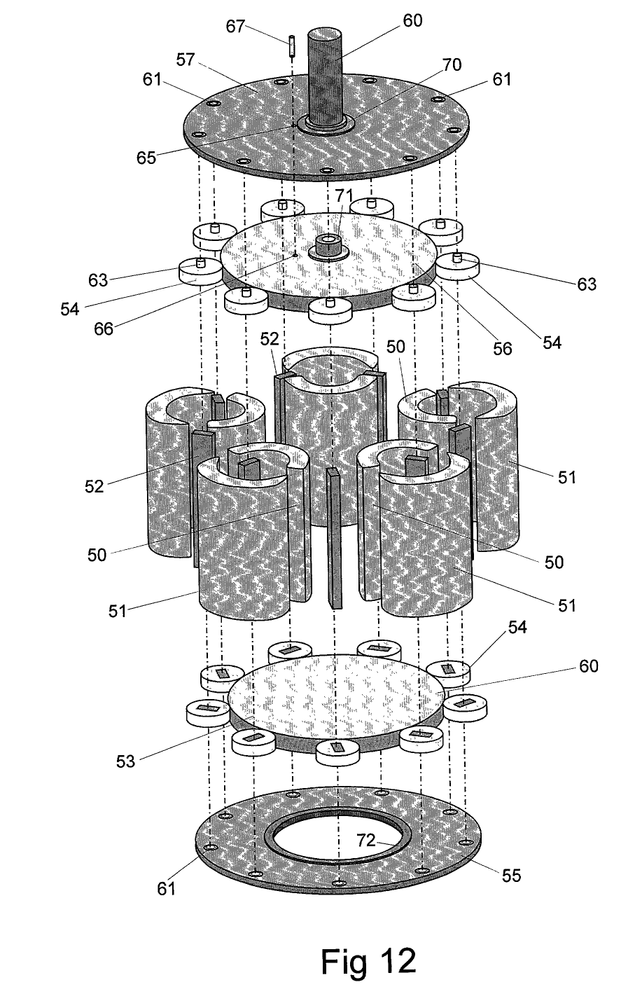

FIG. 12 shows an exploded view of the motor minus the case and outer magnet housing. Most parts have been explained, but are in three dimensions here. The footprints of the small magnets (52) are shown on the lower set of small gears (54) for orientation purposes. The lower bearing housing (55) has a large diameter bearing (72) to allow lower stationary gear (53) to have a large attachment area to contact lower case end (82).

Hole (66) in upper stationary gear (56) and hole (65) in upper bearing housing (57) are there to accept assembly pin (67).

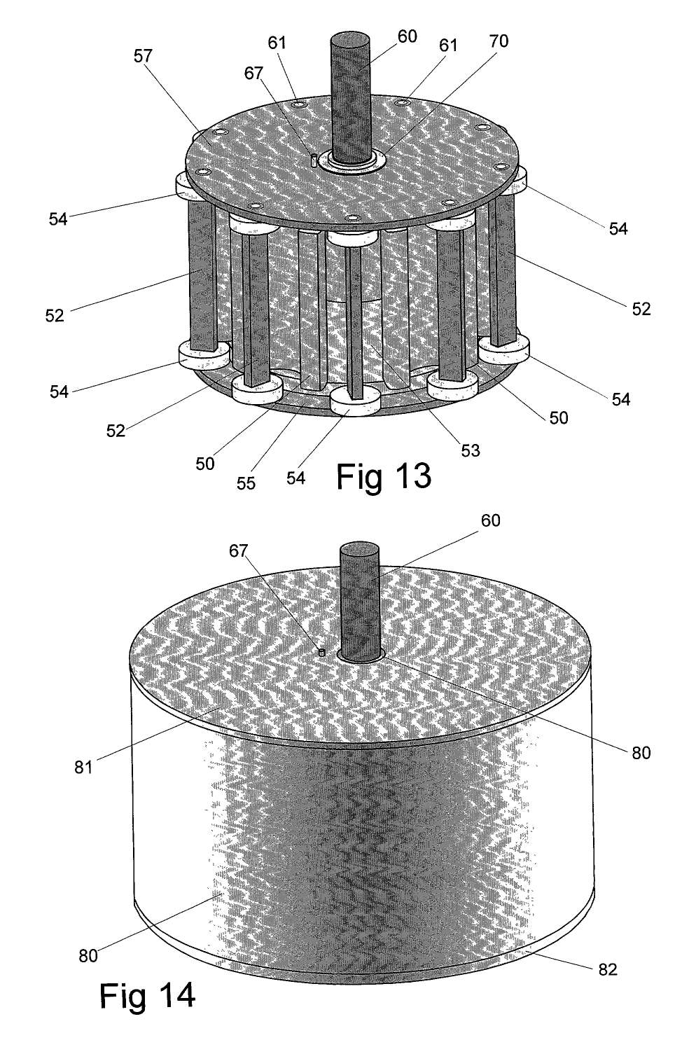

FIG. 13 shows the motor assembled without the case and outer magnet housing. Assembly pin (67) is inserted

FIG. 14 shows the motor with the case installed. The assembly pin (67) remains inserted.

### OPERATION—EMBODIMENT 2

Attractive and repulsive forces are used indirectly to cause rotational movement in the motor. FIG. 3 shows how the fields of large magnet (50) are shaped and contained by the shape and proximity of the poles on large magnet (51). Small magnets (52) rotate as they orbit point “P” and pass through the fields of large magnets (50) and (51) as indicated on FIG. 4. The poles of small magnets (52) are attracted and repelled as they pass through the fields of the large magnets (50) and (51). The attraction and repulsion of the poles on the small magnets (52) cause small magnets (52) to twist in an attempt to attain field alignment with the fields of large magnets (50) and (51).

The twisting action of small magnets (52) is transferred to small gears (54) attached to each end of each small magnet (52) where the twisting action functions as torque. The torque on small gears (54) causes them to rotate and walk around stationary gears (53) and (56). As small gears (54) rotate and walk around stationary gears (53) and (56), they move with them bearing housings (55) and (57) where their bearings are located. The rotation of the upper bearing housing (57) rotates output shaft (60) which protrudes from the upper bearing housing.

Assembly pin (67) prevents the motor from operating prematurely and is not to be removed until the motor is installed and a load or governor is attached to the output shaft. Once assembly pin (67) is removed, the motor will continue to operate until failure occurs or sufficient load is applied.

### DESCRIPTION—EMBODIMENT 3

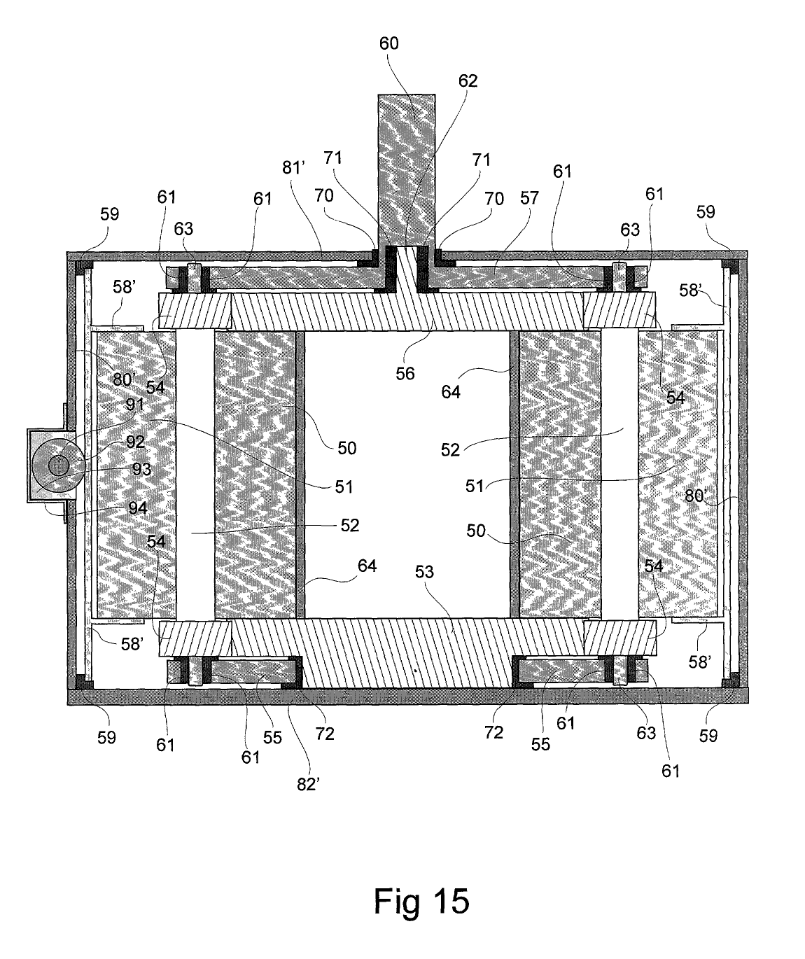

FIG. 15 shows a side view cutaway of embodiment 3 of the invention. Cylinder (64) and large inner magnets (50) are sandwiched between lower stationary gear (53) and upper stationary gear (56) and attached to both. A large extended surface on the bottom of lower stationary gear (53) is attached to the lower case end (82′) and is the seat for bearing (72). Lower case end (82′) is of thick material.

Upper stationary gear (56) has protrusion (62) which is the seat for upper inner bearing (71). Upper inner bearing (71) is the inner bearing for upper bearing housing (57). Upper outer bearing (70) is the outer bearing for upper bearing housing (57) and is seated in upper case end (81′). The cylindrical portion of case (80′) is attached between the two case ends (81′) and (82′). Output shaft (60) protruding from upper bearing housing (57) is the output of the motor.

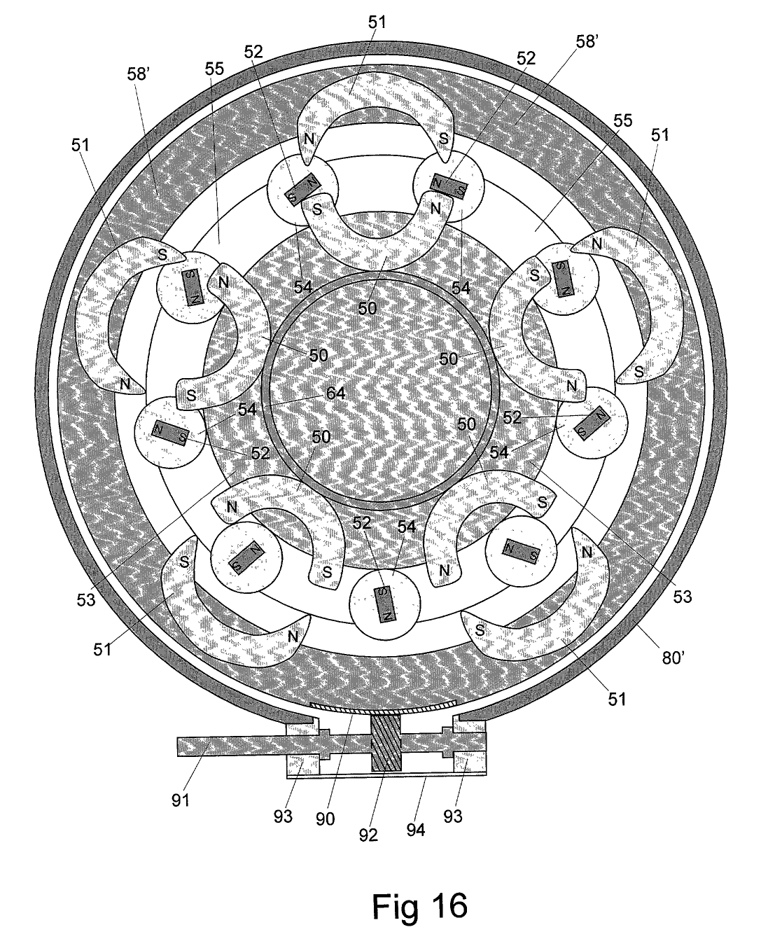

Small gears (54) are attached to each end of the small magnets (52). Shafts (63) that protrude from one side of each small gear (54) fit in the bearings (61) located in lower bearing housing (55) and upper bearing housing (57). The large outer magnets (51) are held in place by outer magnet housing (58′). The outer magnet housing (58′) is seated between outer bearings (59) at the upper and lower extremes of outer magnet housing (58′). Outer bearings (59) hold outer magnet housing (58′) in position while permitting outer magnet housing (58′) to rotate within case (80′). A rotational velocity and torque control mechanism comprising adjustment shaft (91), threaded area on adjustment shaft (92), adjustment housing (93), and adjustment case (94) are attached to case (80′). FIG. 16 shows a top view cutaway of the motor. The shapes and locations of parts are made visible to permit understanding their interaction. Small gears (54) are held in position by lower bearing housing (55) and upper bearing housing (57). Teeth on small gears (54) mesh with teeth on lower stationary gear (53) and upper stationary gear (56). Small magnets (52) are shown in proper orientation. Toothed or threaded area (90) on outer magnet housing (58′) meshes with toothed or threaded area (92) on adjustment shaft (91). Adjustment housing (93) is a fixed reference. The adjustment mechanism is attached to case (80′) by adjustment cover (94).

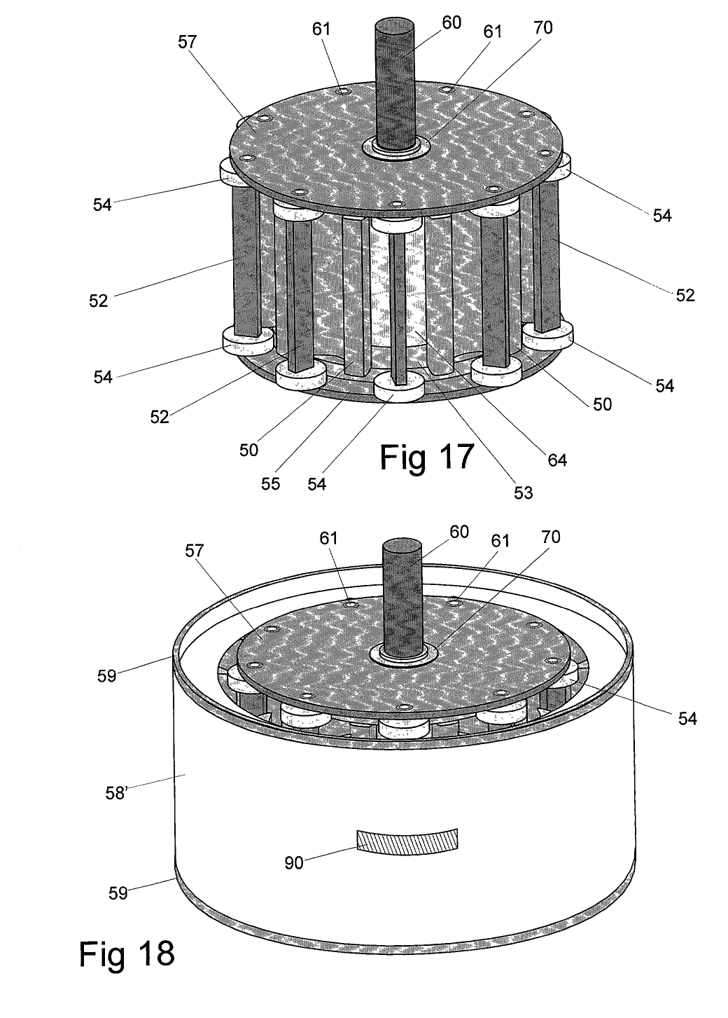

FIG. 17 shows the motor partially assembled without the case and outer magnet housing (58′). FIG. 18 shows the motor with the outer magnet housing (58′) installed, minus the case.

Toothed or threaded area (90) is visible on the front of outer magnet housing (58′).

Outer bearings (59) are also visible on the top and bottom of outer magnet housing (58′).

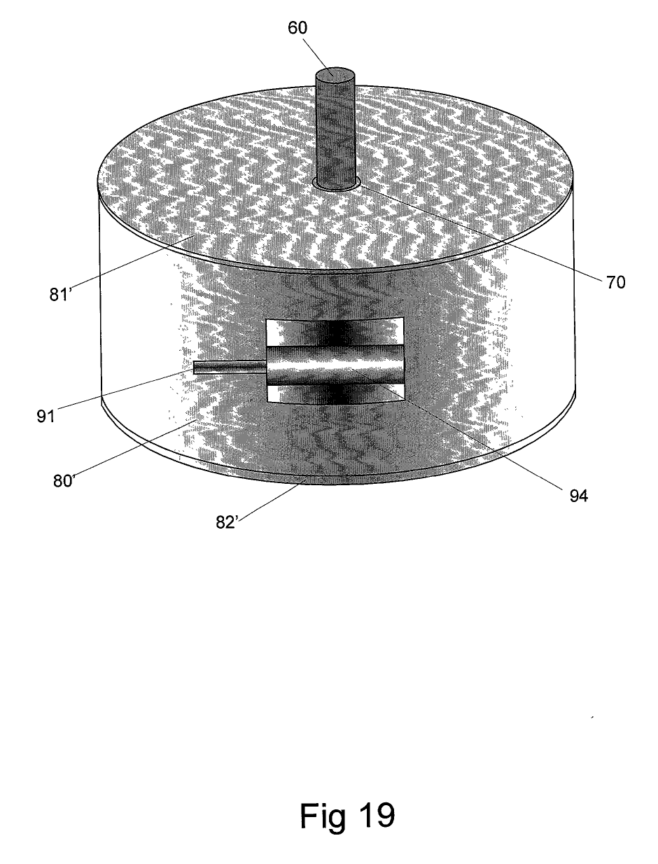

FIG. 19 shows the motor with the case installed. The motor control adjustment case (94) and adjustment shaft (91) are visible.

### OPERATION—EMBODIMENT 3

Attractive and repulsive forces are used indirectly to cause rotational movement in the motor. FIG. 3 shows how the fields of large magnet (50) are shaped and contained by the shape and proximity of the poles on large magnet (51). Small magnets (52) rotate as they orbit point “P” and pass through the fields of large magnets (50) and (51) as indicated on FIG. 4. The poles of small magnets (52) are attracted and repelled as they pass through the fields of the large magnets (50) and (51). The attraction and repulsion of the poles on the small magnets (52) cause small magnets (52) to twist in an attempt to attain field alignment with the fields of large magnets (50) and (51).

The twisting action of small magnets (52) is transferred to small gears (54) attached to each end of each small magnet (52) where the twisting action functions as torque. The torque on small gears (54) causes them to rotate and walk around stationary gears (53) and (56). As small gears (54) rotate and walk around stationary gears (53) and (56), they move with them bearing housings (55) and (57) where their bearings are located. The rotation of the upper bearing housing (57) rotates output shaft (60) which protrudes from the upper bearing housing.

FIG. 16 shows a functional view of the output control. Adjustment housing (93) and adjustment case (94) attach the adjustment mechanism to case (80′). Toothed or threaded area (92) on adjustment shaft (91) meshes with toothed or threaded area (90) on outer magnet housing (58′). Rotating adjustment shaft (91) rotates toothed or threaded area (92) which causes toothed or threaded area (90) on outer magnet housing (58′) to rotate the outer magnet housing. The outer magnet housing (58′) can rotate up to about 12-degrees in either direction from maximum output at the mid point of the adjustment. The motor will stop operating prior to the adjustment reaching either 12-degree extreme. The rotational velocity and torque of the output are controlled by this adjustment.

Theory of Operation

Motion is presently assumed to be the dissipation of force and one would expect the dissipation of force to be the same regardless of the force involved. However, motion will not dissipate force unless the force is produced by motion. Force that exists in the absence of motion cannot be dissipated by motion, but its effect can be neutralized while the motion it produces exists; such as, falling into gravity.

This function of force holds true for all forces that are not due to motion. It is obvious that forces not due to motion are inexhaustible, and when an inexhaustible force is manipulated to produce motion, the motion is relatively inexhaustible.

Conclusion, Ramifications, and Scope

Just as the electric motor can assume various forms, the field force manipulation powered motor can be designed for use in various applications. The motor can be used in many cordless tool applications and convert several items to being cordless; such as, lamps, fans, and heaters. It can be used to power robots and equipment in various remote locations.

Embodiment 1 of the motor can be fitted with wiring and used to generate electricity. The other embodiments can be used to power generators to produce electricity. The motor can be used to replace all forms of nuclear power and thereby eliminate the production of nuclear waste contaminates.

Many so called third world nations are so due to the absence of a suitable form of energy. This situation will be altered by the motor providing the means that they lack. Pollution created by internal combustion engines can be reduced drastically. Unsightly refineries, windmills, and solar panels can be removed from the landscape.

I claim:

1. A field force manipulation powered motor comprising:
a plurality of large magnets held stationary, and a plurality of small magnets attached to small gears, said small gears are attached to bearing housings, and mesh with large stationary gears that function collectively to manipulate said small magnets,
thereby becoming a means of manipulation that controls the orientation of said small magnets, causing the force fields of said small magnets to be constantly misaligned predominately perpendicular with the force fields of said large magnets, compelling said small magnets to attempt to achieve field force alignment with said large magnets that creates torque on said small magnets,
said torque is transferred from said small magnets to said small gears, causing said small gears to walk around said large stationary gears which rotate said bearing housings, whereby rotational energy is made available for use.

2. A field force manipulation powered motor comprising:
a plurality of large inner magnets held stationary, a plurality of large outer magnets held stationary by an outer magnet housing, and a plurality of small magnets attached to small gears, said small gears are attached to bearing housings, and mesh with large stationary gears that function collectively to manipulate said small magnets,
thereby becoming a means of manipulation that controls the orientation of said small magnets, causing the force fields of said small magnets to be constantly misaligned predominately perpendicular with the force fields of said large inner magnets and said large outer magnets, compelling said small magnets to attempt to achieve field force alignment with said large inner magnets and said large outer magnets that creates torque on said small magnets, said torque is transferred from said small magnets to said small gears, causing said small gears to walk around said large stationary gears which rotate said bearing housings, whereby rotational energy is made available for use.

3. The field force manipulation powered motor of claim 2 wherein said means of manipulation can be impaired by the rotation of said outer magnet housing of said plurality of large outer magnets, allowing the rotation of said means of manipulation to be adjustably controlled, whereby controllable rotational energy is made available for use.
